(19) United States
(12) Patent Application Publication
(10) Pub. No.: US 2004/0059468 A1
(43) Pub. Date: Mar. 25, 2004

(54) Method for controlling or regulating the energy flow in a measuring system which can be composed of a plurality of individual modules

(76) Inventors: Andreas Derr, Wutoeschingen (DE); Manfred Streicher, Lenzkirch (DE); Karl Schuler, Titisee-Neustadt (DE)

Correspondence Address: Choate Hall & Stewart, Patent Group, Exchange Place, 53 State Street, Boston, MA, 02109-2804, US

(21) Appl. No.: 10/450,322

(22) PCT Filed: Nov. 30, 2001
(86) PCT No.: PCT/EP01/14033

(30) Foreign Application Priority Data
Dec. 12, 2000 (DE) 100 61 871.5

(51) Int. Cl. G05D 11/00

(52) U.S. Cl. 700/286; 700/295

(57) ABSTRACT

The invention relates to a method for controlling or regulating the energy flow in a measuring system which can be composed of a plurality of individual modules. Part or all of said individual modules are respectively connected by means of at least one energy supply line and at least one data line. At least one of said individual modules comprises an interface via which energy can be supplied. An energy balance table is created in at least one individual module on the basis of energy data from the connected individual modules. The energy supply and/or energy removal to/from the individual modules are controlled or regulated according to the data stored in the energy balance table.

The present invention relates to a method of controlling or regulating the power flow in a measuring system composed of a plurality of intermateable individual modules as recited in the preamble of claim 1 and a measuring system composed of a plurality of intermateable individual modules as recited in the preamble of claim 20.

Housings or receptacles into which a limited number of slide-in cards may be inserted are known from the related art. These systems are known to those skilled in the art as 19″ racks or the like.

Such modular slide-in cards, which are preferably boards carrying an electric or electronic circuit arrangement, normally have one or more data line connectors which, by inserting the slide-in cards into an above-mentioned receptacle, are plugged into a plug-in unit situated on the rear panel of the particular receptacle.

All plug-in units situated on the rear panel of a receptacle normally have a uniform design and the corresponding contacts of the individual module positions are connected to one another via an electric connection. It is achieved in this way that the slide-in cards inserted into the receptacle are interconnected in the form of a bus.

Although such a system has proved itself, the inherent disadvantage lies in the fact that the receptacle may only accept a limited number of slide-in cards and that the individual cards must all be of uniform design. Inserting slide-in cards having very different functions and a very different utilization performance is not provided for. In addition, such a system is normally fixedly installed so that the dimension of the power supply etc. is normally designed according to the specific application.

However, modern measuring technology requires that such a system is freely scalable, that it may be set up and dismantled at any location, and that single (measuring) devices of the most diverse type may be assembled to form a complete system.

The object of the present invention is therefore to provide a system which no longer has the disadvantages mentioned above. In particular, a system is to be provided which is freely scalable in any way and in which components may be added or removed again in any way, without the operational readiness of the entire measuring system being compromised. Moreover, the use at almost any location is to be made possible.

This object is achieved according to the present invention by a measuring system being composed of a plurality of intermateable individual modules and having the features as recited in the preamble of claim 20, as well as according to the present invention by a method of operating such a measuring system as recited in claim 1.

Advantageous embodiments and refinements of the present invention are cited in the subclaims.

The present invention is generally directed to a measuring system composed of a plurality of intermateable individual modules, part or all of these individual modules being connectable via at least one power supply line and at least one data line, and at least one individual module of these interconnected individual modules having an interface via which (preferably electric) power is suppliable.

The essential idea of the present invention is that a memory for preparing a power balance table based on power data from the connected individual modules is provided in at least one individual module, and a control or regulating unit is provided for controlling or regulating the power flow based on the data stored in the power balance table.

Only such a system ensures that the operation of the entire measuring system is not disrupted due to increased power consumption of a single module. In this way it is made possible that the measuring system may be added to in any way by additional modules without impairing the functionality of other modules. Furthermore, it is possible to flexibly operate such a system at almost any location.

The present invention provides that component-related data, permanently stored in a memory of an individual module, is used as power data. It is possible in this way to quickly and dynamically adapt the power balance table to the particular individual components of the measuring system and to the particular measuring requirements.

It is provided here that this component-related data is stored in an EEPROM of an individual module, for example. Storage in an EEPROM has the advantage that component-related data may be quickly added to, or may be replaced by updates. Almost every individual module may be equipped with such a memory in a simple manner; be it a measuring module, an analog-digital/digital-analog converter module, a power supply module, a radio module, a climatic data capture module, or a flue gas measuring module, etc.

The present invention provides that the nominal operating load data in a basic version is used as component-related data. Based on the nominal operating load data, the control or regulating unit then decides whether and which individual modules are to be activated, whether individual modules need to be switched off, and whether power consumption needs to be limited.

Furthermore, the present invention provides that the standby and/or sleep-mode load operation data is used as component-related data. The individual modules do not participate freely in the bus communication in such a mode; however, the individual modules or parts thereof may be activated. Since power consumption also occurs in this state, it is necessary to also include it in the power balance.

It is essential, following the same reasoning and justification, to also include the maximum load data, in particular also where applicable with a chronological assignment (if possible), in the component-related data, all the more so, if there is a large discrepancy between the maximum load data and the nominal operating load data.

Furthermore, the present invention provides that the closing load data and/or the change of state load data is used as component-related data. As a rule, such data may be determined in advance for each individual module. It is not necessary to first determine this data during the running operation and to subsequently include it in the power balance table.

Nevertheless, the present invention provides that power data from the dynamic operation is also included in the power balance. This is all the more necessary since communication normally takes place between the individual modules, based on which individual modules are connected or switched off or have a temporarily higher or lower power demand.

The present invention provides that statistical data on the operating state of the connected individual modules is used as dynamic operation data. However, the use of such data is appropriate only if a plurality of modules are unchangingly interconnected over a longer measuring period or communication period.

The present invention provides that data on the operating load, operating period or the like is used as statistical data on the operating state. Recurring processes, in particular when the recurrence occurs cyclically, may then be included in the power balance in advance so that, in times of low load, individual modules may be connected at short notice or, vice versa, individual modules may be disconnected from the complete system at short notice.

A further particularly advantageous variant of an embodiment of the present invention provides that data on the charge state of a connected accumulator, of batteries or the like is used as dynamic operation data. In this way, the system may flexibly react to dynamic load changes, in that, for example, an accumulator charge operation is switched over to an accumulator discharge operation, or supply is additionally provided via connected batteries or the like.

The present invention further provides that data to be determined by a priority of the regulation of the power supply and/or the power consumption is used as dynamic operation data and/or component-related data. This prevents sudden load variations which prevent an uninterrupted measuring operation. In addition, where needed, high load consumers are disconnected step by step, and sudden load variations are buffered by internal accumulators, batteries or the like. This measure is particularly appropriate in combination with starting current limiting or the like in the starting phase of an additional consumer.

The present invention provides that the power balance table is created at the first start-up, i.e., all data required or available for preparing such a power balance table is read into the memory of the “master module” after switching on the complete system.

It is advantageous here if the power balance table is subsequently also updated cyclically. In particular, this ensures that newly added components, disconnected components as well as changes in the operating state are detected early, that they are incorporated in the consideration of statistical data, and that regulating or controlling reactions are triggered.

Furthermore, the present invention provides that the power balance table is configured by the user. This includes in particular that, for measuring program processes that are to be executed, anticipatory “power supply planning” may be carried out. In particular, this makes it possible to detect deficits in advance, and, where needed, to provide the necessary power supply modules or power system connections.

Furthermore, the present invention provides that the individual module having the power balance table detects the connected individual modules independently and reads in the data necessary for preparing the power balance table. In addition to identifying the actual measuring modules, operator modules, etc., this also includes the detection of power supply modules such as accumulators, batteries or the like, as well as power system connections.

Furthermore, the present invention provides that the individual module, and in particular the control or regulating unit, authorizes the release of the power supply and/or the power consumption based on the power balance table, and that it makes a check based on a plausibility check with reference to this power balance table. Changes in the system do not occur immediately upon connecting a new additional individual module, but only after release by the “master module.” The present invention provides that the release of the power supply and/or the power consumption is authorized successively with individual modules being simultaneously connected. This is particularly appropriate in the case when individual modules, which have a high level of power consumption and which in particular generate a high load during the connection process, are being connected simultaneously.

A further variant provides that as a function of a load increase or a load decrease, an accumulator charge operation is switched over to an accumulator discharge operation, or vice versa. This measure yields the result that power from the accumulators is only drawn when alternative sources are not available. In addition, this ensures that charging of the accumulators always takes place when power abounds so that, if needed, the adequate availability of the accumulator as the power source is ensured.

A further variant of the present invention provides that power supply via accumulators or batteries is switched off when power supply takes place via a power supply unit. This yields the result that the exhaustible power sources are engaged for maintaining the power supply only when it is absolutely essential. The service life of the accumulators or batteries is further increased in this way.

In addition, a differentiation is made between accumulators or batteries as exhaustible power sources. This is particularly important when the power supply takes place via a power supply unit, and when, for example with an accumulator, the power made available via this power supply unit may be used to charge the accumulator, while charging of batteries may not take place.

An exemplary embodiment of the present invention is illustrated in the drawing and is explained in greater detail in the following.

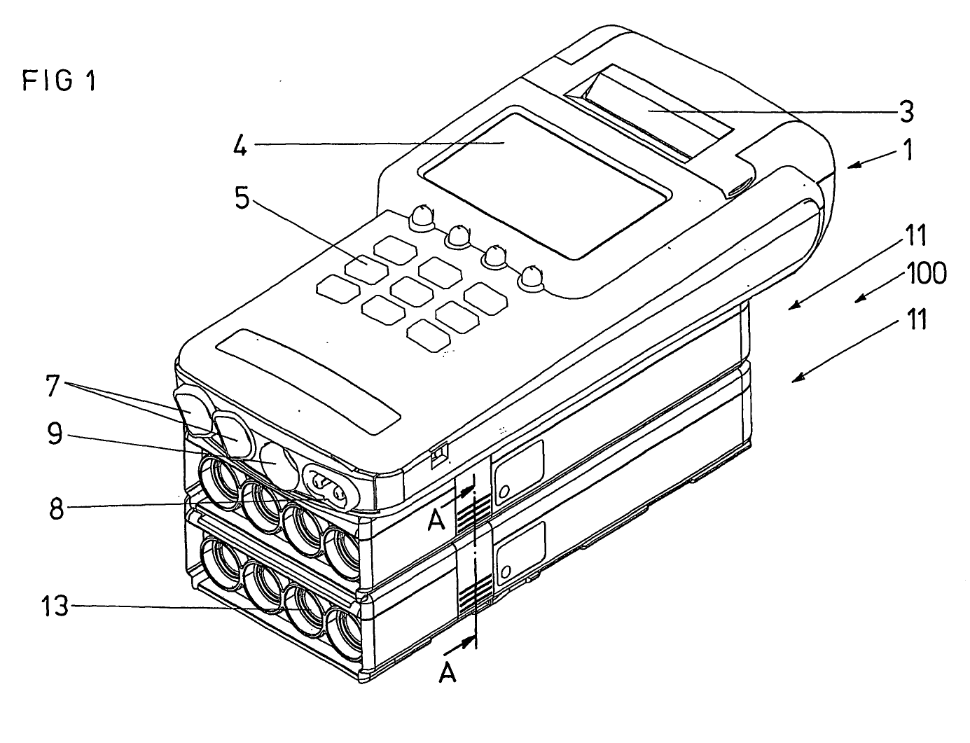

FIG. 1 shows a measuring system according to the present invention based on an operator module and two measuring modules,

perspective illustration

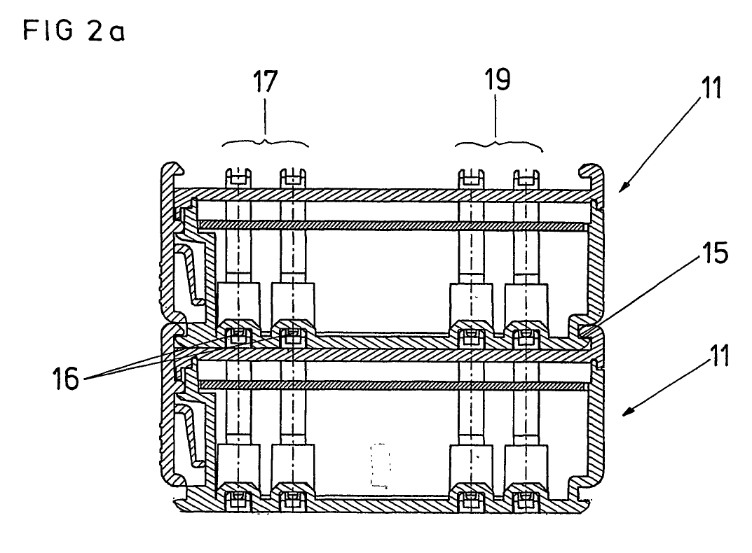

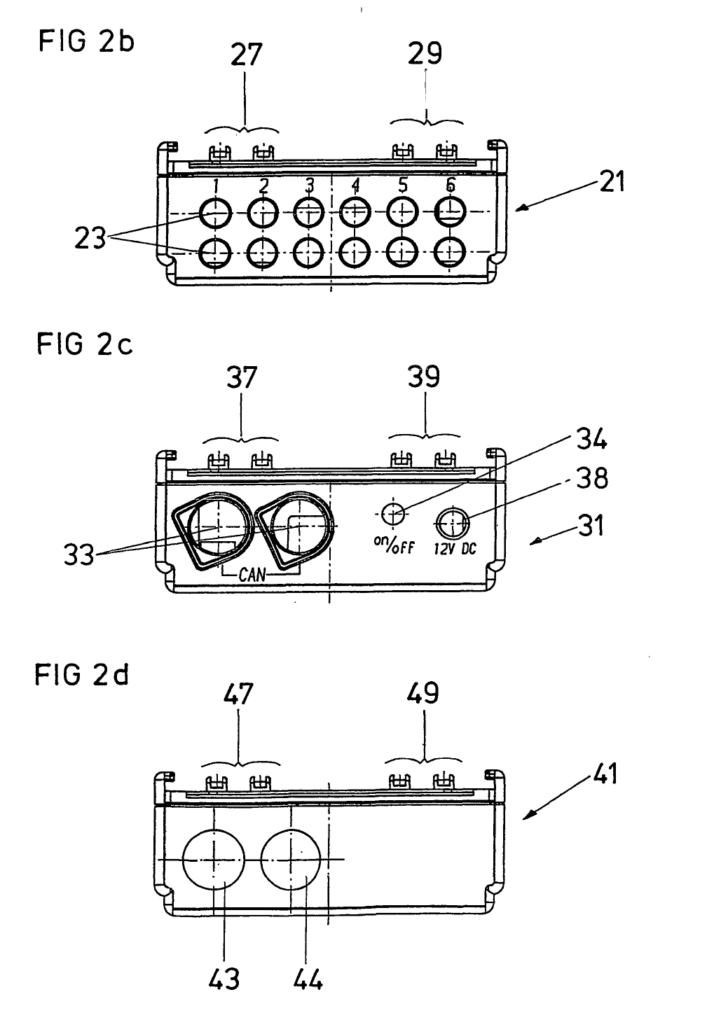

FIG. 2 shows individual modules according to the present invention,

a) measuring modules, connected mechanically and electrically conductively

illustration of a cross section along plane A-A according to FIG. 1

b) analog-digital/digital-analog converter module

isometric illustration

c) power supply module

isometric illustration

d) radio module

isometric illustration

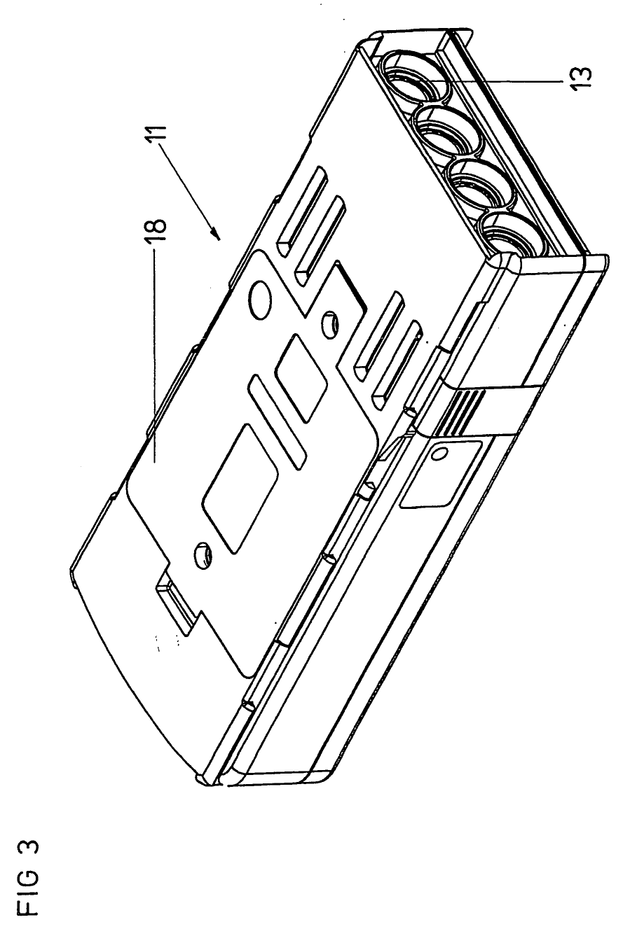

FIG. 3 shows a measuring module according to the present invention,

perspective illustration in a bottom view

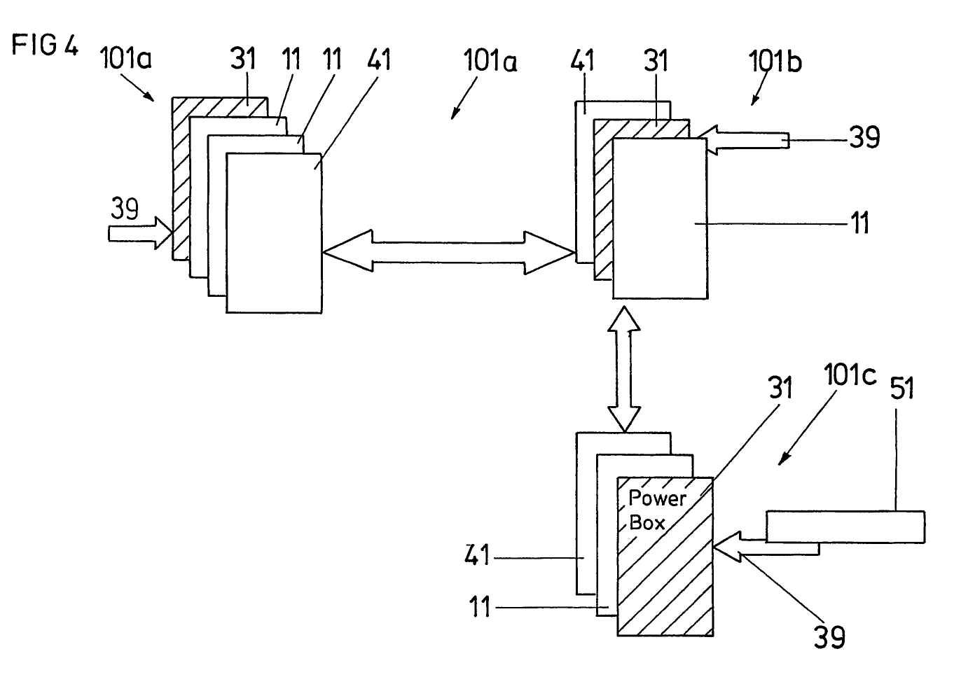

FIG. 4 shows a schematic illustration of a power flow and an information flow in a measuring system according to the present invention.

FIG. 1 shows a measuring system according to the present invention in which the method according to the present invention is implemented for controlling or regulating the power flow. In the example according to FIG. 1, measuring system 100 is based on an operator module 1 and two measuring modules 11, intermateably connectable thereto.

On its front, operator module 1 has elements necessary for operation. In the present case, this is a key pad 5 for entering a measuring program, for setting parameters, and for entering additional operating functions; a display panel 4 for displaying the data entered, as well as for indicating measured values, configuration data, operating data, etc. In addition, a printer 3 is provided in operator module 1 according to FIG. 1, which is used for printing measuring logs, as well as for preparing other reports.

Entire operator module 1 in the example is designed as a hand-held unit; however, it is also conceivable to use a stationary module as an operator unit, such as a personal computer or the like.

Operator module 1 is connected to two measuring modules 11, mechanically and electrically conductively, as is explained in the following. In the example according to FIG. 1, electrically conductive contacting is implemented directly on the corresponding opposite surfaces of the housings of measuring modules 11 and operator module 1. The method according to the present invention is not limited to such systems; it is also conceivable that data lines and power supply lines are connected via plug-in systems or the like, which are mounted on the housing.

For example, possible plug-in connections are provided on the fronts of individual modules 1 and 11 in the system illustrated in FIG. 1. In this arrangement and recognizable on the front are two data line connectors 7, one power supply unit connector 8, and a trigger connector 9, situated on operator module 1, while four measuring sensor connectors 13 are situated on the front of the measuring module. Additional data line connectors and power supply line connectors situated on the rear panels of modules 1 and 11 are not illustrated here.

FIG. 2a shows how two measuring modules 11 are connected to each other, mechanically as well as electrically conductively. FIG. 2 illustrates that both modules 11 have contact surfaces, situated opposite one another, which may be brought in contact with the contact surfaces of another module 11. A mechanical locking mechanism 15, which is not described in greater detail here, is situated on the particular contact surfaces.

Electrical (or optical) contacts 17 and 19 are also incorporated in the particular contact surfaces, via which in the connected state, i.e., contact surfaces being in contact against each other, an electrical (or optical) contact may be established between individual modules 11. A plurality of individual modules “stacked” on top of one another are thus connected to one another in the form of a bus.

FIGS. 2b, 2c, and 2d show additional individual modules which may be assembled to form a measuring system according to the present invention. FIG. 2b shows an analog-digital/digital-analog converter module having data line connectors 27 and power supply line connectors 29 which are incorporated in the particular contact surfaces in the way described above. In addition, analog output connectors 23, designed as plug-ins for external units, are incorporated in the front of analog-digital/digital-analog converter module 21.

FIG. 2c shows another individual module, namely a power supply module 31. Power supply module 31 is provided for accommodating a larger number of accumulators, batteries or the like in its housing. In addition, it has a power supply unit connector 38 via which a power system connection may be established. The connection of power supply module 31 to the other modules of the type described above also takes place via power supply line connectors and data line connectors 37 and 39, respectively, which are looped through the housing. Furthermore, this module has data bus connectors 33 via which additional units may be connected. It is also provided that the power supply via power supply module 31 may be switched on and off by using on-off switch 34, so that when off, for example, power supply module 31 may only be used as a plug-in connection for creating a data bus connector 33 to an external unit.

In a similar way, measuring modules 11 may also be provided with a power supply unit. FIG. 3 shows such a measuring module 11.

FIG. 2d shows another individual module which is integratable into a system according to the present invention. In this case it is a radio module 41. This radio module 41, including data line connectors 47 and power supply line connectors 49 which are known and have been described in detail earlier, has a transmitter 43 and a receiver 44. The present invention provides that such a radio module 41 may used for data exchange with another radio module 41 of similar type.

Finally, FIG. 4 exemplarily shows an arrangement of a measuring system 101 based on multiple (in this case, three) measuring subsystems 101a, 101b, 101c which are spatially separate from one another.

In the example, measuring subsystem 101a is composed of one power supply module 31 and two measuring modules 11, and measuring subsystems 101b and 101c are composed of one power supply module 31 and one measuring module 11. All measuring subsystems 101a, 101b, 101c have one radio module 41 each which may communicate with one another via a wireless connection (radio, infrared, ultrasound, or the like).

In addition it is provided that external (electrical) power may be supplied via the particular power supply modules 31 using a particular connection to a plug-in power supply unit 51.

It is adequate in such a complete system for one individual module of one subsystem 101a, 101b, or 101c to assume the function of the “master” by controlling or regulating the power supply/power consumption of the other individual modules of the subsystem via a direct “wire” connection, and the other individual modules of the remaining subsystems via a radio connection.

List of Reference Numbers

1 operator module

3 printer

4 display panel

5 key pad

7 data line connector

8 power supply unit connector

9 trigger connector

11 measuring module

13 measuring sensor connector

15 mechanical locking mechanism

16 electrical contact mechanism

17 data line connector

18 battery receptacle

19 power supply line connector

21 analog-digital/digital-analog converter module

23 analog output connectors

27 data line connector

29 power supply line connector

31 power supply module

33 data bus connector

34 on-off switch

37 data line connector

38 power supply unit connector

39 power supply line connector

41 radio module

43 transmitter

44 receiver

47 data line connector

49 power supply line connector

51 plug-in power supply unit

100 measuring system

101 measuring system

101a measuring subsystem

101b measuring subsystem

101c measuring subsystem

What is claimed is:

1. A method of controlling or regulating the power flow in a measuring system (100, 101) composed of a plurality of intermateable individual modules (1, 11, 21, 31, 41), part or all of these individual modules (1, 11, 21, 31, 41) being connected via at least one power supply line (19, 29, 39, 49) and at least one data line (17, 27, 37, 47), at least one individual module (1, 31) of these individual modules having an interface (8, 18, 38) via which power is suppliable,
wherein a power balance table is prepared in at least one individual module (1) based on power data from the connected individual modules (1, 11, 21, 31, 41); and the power supply and/or power consumption of the individual modules (1, 11, 21, 31, 41) is controlled or regulated based on the data stored in the power balance table.

2. The method as recited in claim 1,
wherein component-related data, permanently stored in a memory of an individual module (1, 11, 21, 31, 41), is used as power data.

3. The method as recited in claim 2,
wherein the nominal operating load data is used as component-related data.

4. The method as recited in claim 2 or 3,
wherein the standby and/or sleep-mode load operation data is used as component-related data.

5. The method as recited in one of claims 2 through 4, wherein the maximum load data is used as component-related data.

6. The method as recited in one of claims 2 through 5, wherein the closing load data and/or the change of state load data is used as component-related data.

7. The method as recited in one of the preceding claims, wherein dynamic operation data is used as power data.

8. The method as recited in claim 7,
wherein statistical data on the operating state of the connected individual modules (1, 11, 21, 31, 41) is used as dynamic operation data.

9. The method as recited in claim 8,
wherein data on the operating load, operating period or the like is used as statistical data on the operating state.

10. The method as recited in one of the preceding claims, wherein data on the charge state of a connected accumulator, of batteries or the like is used as dynamic operation data.

11. The method as recited in one of the preceding claims, wherein data determining a priority of the regulation or control of the power supply and/or the power consumption is used as dynamic operation data and/or component-related data.

12. The method as recited in one of the preceding claims, wherein the power balance table is created at the first start-up.

13. The method as recited in one of the preceding claims, wherein the power balance table is updated cyclically.

14. The method as recited in one of the preceding claims, wherein the power balance table is configured by the user.

15. The method as recited in one of the preceding claims, wherein the individual module (1) having the power balance table detects the connected individual modules (11, 21, 31, 41) independently and reads in the data necessary for preparing the power balance table.

16. The method as recited in one of the preceding claims, wherein the individual module (1) having the power balance table authorizes the release of the power supply and/or power consumption.

17. The method as recited in one of the preceding claims, wherein the release of the power supply and/or the power consumption is authorized successively with individual modules (1, 11, 21, 31, 41) being connected simultaneously.

18. The method as recited in one of the preceding claims, wherein, as a function of a load increase or a load decrease, an accumulator charge operation is switched over to an accumulator discharge operation, or vice versa.

19. The method as recited in one of the preceding claims, wherein the power supply via accumulators or batteries is switched off when the power supply takes place via a power supply unit (51).

20. A measuring system (100, 101) composed of a plurality of intermateable individual modules (1, 11, 21, 31, 41), part or all of these individual modules (1, 11, 21, 31, 41) being connectable via at least one power supply line (19, 29, 39, 49) and at least one data line (17, 27, 37, 47), at least one individual module (1, 31) of these individual modules having an interface (8, 18, 38) via which power is suppliable,
wherein a memory for preparing a power balance table based on power data from the connected individual modules and a control or regulating unit for controlling or regulating the power flow based on the data stored in the power balance table are provided in at least one individual module (1).

21. The measuring system as recited in claim 20, wherein each individual module (1, 11, 21, 31, 41) has at least one memory for component-related data; and at least one individual module (1) has a memory for reading in the component-related data stored in the memories of the individual modules (1, 11, 21, 31, 41), and a control or regulating unit for controlling or regulating the power flow.

22. The measuring system as recited in claim 21,
wherein
